(19) United States
(12) Patent Application Publication
(10) Pub. No.: US 2010/0199626 A1
(43) Pub. Date: Aug. 12, 2010

(54) TURBINE ENGINE EXHAUST GAS TUBE MIXER

(76) Inventors: Benjamin Roland Harding, Greenwood, IN (US); Stephen A. Bergeron, Indianapolis, IN (US)

Correspondence Address: KRIEG DEVAULT LLP, ONE INDIANA SQUARE, SUITE 2800, INDIANAPOLIS, IN, 46204-2079, US

(21) Appl. No.: 12/623,987

(22) Filed: Nov. 23, 2009

Related U.S. Application Data
(60) Provisional application No. 61/203,981, filed on Dec. 31, 2008.

(51) Int. Cl. F02C 7/16; B21D 26/02; B23P 11/00

(52) U.S. Cl. 60/39.5; 72/61; 29/889.2

(57) ABSTRACT

An exhaust mixer for an engine is provided having multiple flow tubes arranged in an annular array. A cooling space is formed to allow the passage of cooling air between the flow tubes and within the annular array. In one form the exhaust mixer can be constructed from multiple, individual exhaust flow tubes. The flow tubes can be constructed to engage neighboring flow tubes to create the annular array of exhaust flow tubes. The flow tubes can be interchangeable with other flow tubes.

### CROSS REFERENCE TO RELATED APPLICATIONS

The present application claims the benefit of U.S. Provisional Patent Application 61/203,981, filed Dec. 31, 2008, and is incorporated herein by reference.

### GOVERNMENT RIGHTS

The present application was made with the United States government support under Contract No. N00019-04-G-0007, awarded by the United States Navy. The United States government has certain rights in the present application.

### TECHNICAL FIELD

The present invention generally relates to engine exhaust mixers, and more particularly, but not exclusively, to gas turbine engine exhaust mixers.

### BACKGROUND

Providing a reducing in heat signature of gas turbine engines remains an area of interest. Some existing systems have various shortcomings relative to certain applications. Accordingly, there remains a need for further contributions in this area of technology.

### SUMMARY

One embodiment of the present invention is a unique exhaust gas tube mixer. Other embodiments include apparatuses, systems, devices, hardware, methods, and combinations of gas turbine engine mixers. Further embodiments, forms, features, aspects, benefits, and advantages of the present application shall become apparent from the description and figures provided herewith.

### BRIEF DESCRIPTION OF THE FIGURES

FIG. 1a depicts an aircraft having a mixer.

FIG. 1b depicts a view of a mixing system.

FIGS. 2a, 2b, and 2c depict views of one embodiment of the present application.

FIG. 3 depicts a view of one embodiment of the present application.

FIG. 4 depicts a view of one embodiment of the present application.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

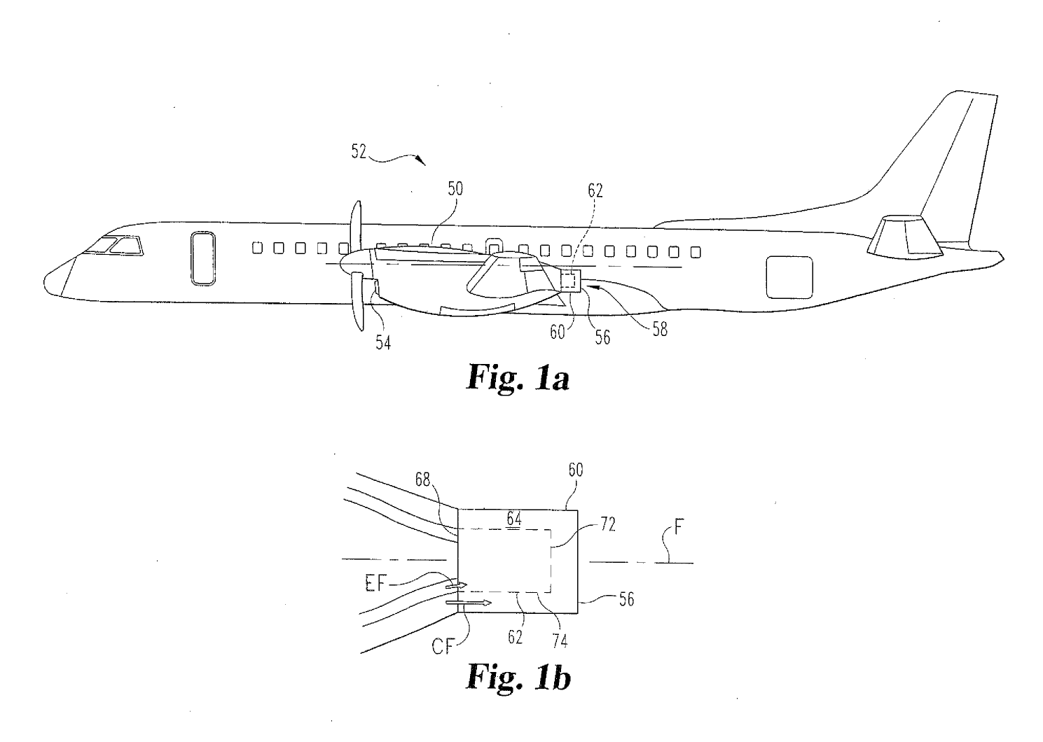

With reference to FIGS. 1a and 1b, there is illustrated a schematic representation of one form of an engine 50 used as a powerplant for an aircraft 52. As used herein, the term “aircraft” includes, but is not limited to, helicopters, airplanes, fixed wing vehicles, variable wing vehicles, rotary wing vehicles, unmanned combat aerial vehicles, tailless aircraft, hover crafts, and other airborne and/or extraterrestrial (spacecraft) vehicles. Further, the present inventions are contemplated for utilization in other applications that may not be coupled with an aircraft such as, for example, industrial applications, power generation, pumping sets, naval propulsion and other applications known to one of ordinary skill in the art. The engine 50 can be a gas turbine engine in some embodiments and can take on a variety of gas turbine engine forms such as, but not limited to, turboshaft and turboprop engines.

Exhaust produced by the engine 50 flows along an exhaust pathway and exits at discharge 56. Mixing system 58 is provided along this exhaust pathway and includes a duct 60 defining a discharge 56, and mixer 62 (shown in phantom) positioned in the duct 60. The mixing system 58 includes passage 64 disposed between the duct 60 and the mixer 62. Mixer 62 is coupled to the turbine outlet of engine 50 which in some embodiments takes the form of an annular flow passage.

During engine operation, inlet 68 of mixer 62 is arranged to receive hot exhaust gases for intermixing with relatively cooler gases before being discharged through discharge 56. In FIG. 1b, the hot exhaust flow from engine 50 is designated by arrow EF. A stream of cooling fluid designated by arrow CF flows through passage 64 to be mixed with exhaust flow EF downstream of an outlet 72. This cooling fluid can be air from an outside inlet, compressor stage, or fan stage of the engine 50, but in other forms the cooling fluid can take on other forms.

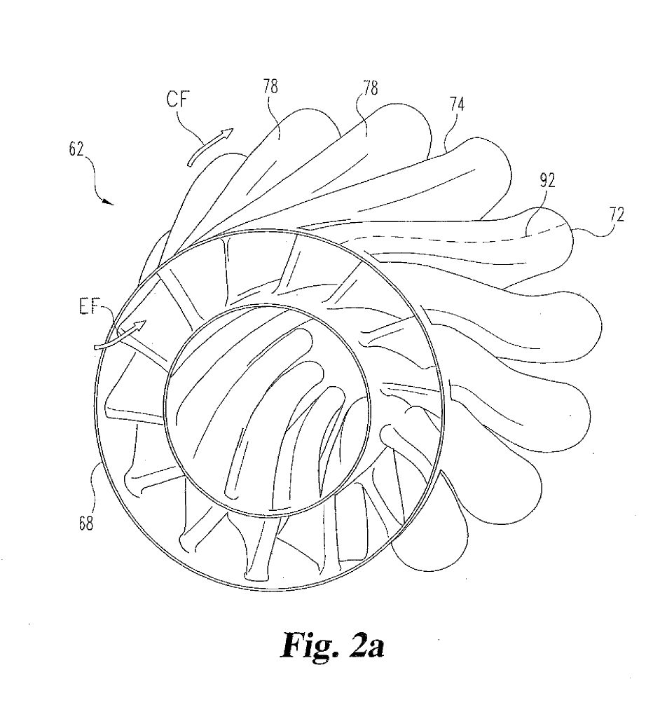

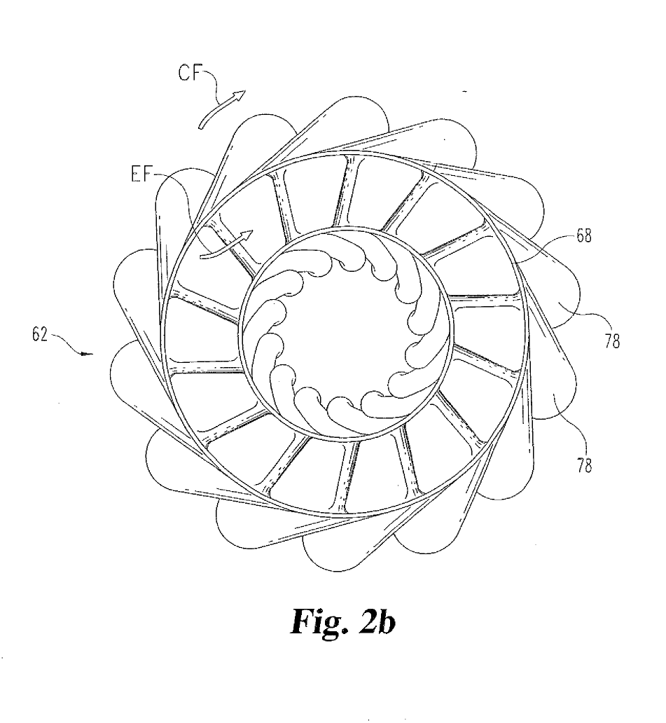

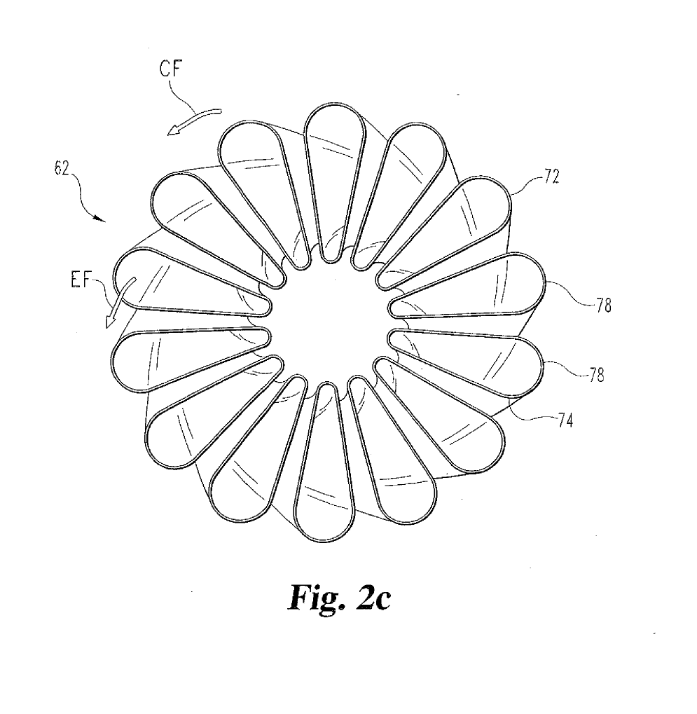

Turning now to FIGS. 2a, 2b and 2c, one embodiment of the mixer 62 is shown in a perspective view, front view, and rear view. The mixer 62 is operable to flow in an exhaust flow EF through its passages and entrain a cooling air CF between surfaces of the mixer 62 for mixing. The mixer 62 includes a number of exhaust flow tubes 78 arranged in an annular configuration. The exhaust flow tubes 78 in the illustrated embodiment have the same shape, size, and orientation and form an array of exhaust flow tubes having cyclic symmetry. In some embodiments, however, one or more of the exhaust flow tubes 78 can have a different shape, size, and/or orientation either along the entire length of the exhaust flow tube 78 from the inlet 68 to the outlet 72 or over a smaller portion or portions of the length of the exhaust flow tube 78. To set forth just one non-limiting example, the exhaust flow tubes 78 can have the same shape, size, and orientation from the inlet 68 to a position intermediate the inlet 68 and outlet 74 at which point the exhaust flow tube 78 can take on a different shape, size, and/or orientation. In some forms the exhaust flow tubes 78 can have a periodic symmetry in that every other tube has the same shape, size, and orientation. In still other forms the array of exhaust flow tubes 78 can include pairings of exhaust flow tubes that have the same shape, size, and orientation, and that the pairings vary around the annular assembly of exhaust flow tubes 78. Other variations are contemplated herein.

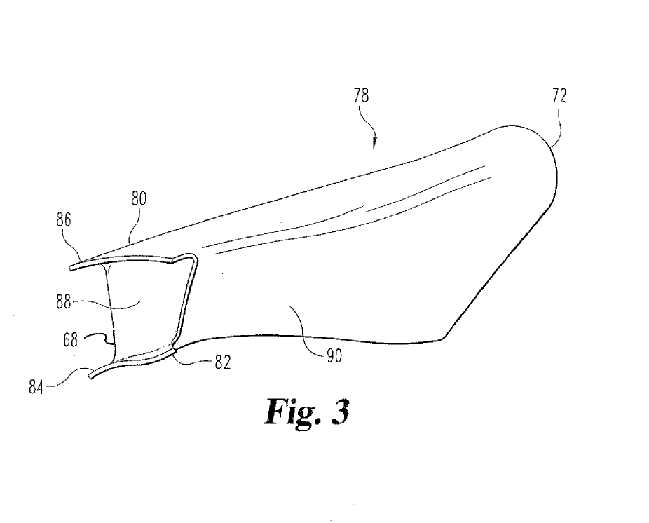

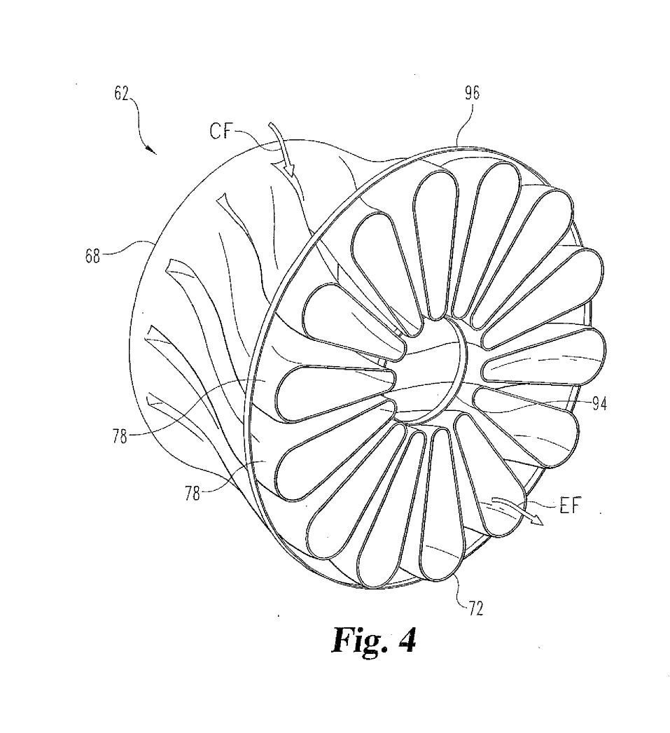

Turning now to FIG. 3, one form of the mixer 62 (as seen in FIGS. 2a, 2b, 2c and 4) includes a plurality of independently constructed exhaust flow tubes 78. The exhaust flow tubes 78 include a side 80 and a side 82. Given the relative orientation of sides 80 and 82 as depicted in FIG. 3, for convenience of description side 80 will hereinafter be referred to as a left side 80 and side 82 will be referred to as a right side 82. However, it will be understood that the terms “left” and “right” are meant for convenience of description and are not intended to be limiting in the embodiment or in any given application of the mixer 62. The left side 80 can be constructed to engage a right side 82 of a neighboring exhaust flow tube 78 (not depicted). Likewise, the right side 82 can be constructed to engage a left side 80 of another neighboring exhaust flow tube 78 (not shown). The configurations of left side 80 and right side 82 allow the exhaust flow tubes 78 to be interchanged with any other given exhaust flow tube 78 included in the annular array of exhaust flow tubes 78 of the mixer 62. In some embodiments of the annular array of exhaust flow tubes 78, the exhaust flow tubes 78 may be formed with an adjacent exhaust flow tubes 78, such that the pairing of the adjacent exhaust flow tubes 78 includes a left side 80 and a right side 82 that can be assembled with sides 82 and 80, respectively, of other pairs or other individual exhaust flow tubes 78. Other variations are also contemplated herein; for example, three or more exhaust flow tubes 78 can be constructed together and engaged with adjacent collections of exhaust flow tubes 78 or single exhaust flow tubes 78. In one form, the left side 80 of any given exhaust flow tube 78 or collection of exhaust flow tubes 78 is arranged to engage with the right side 82 of neighboring exhaust flow tubes 78 or the right side 82 of a collection of exhaust flow tubes 78.

The exhaust flow tubes 78 of the illustrative embodiment includes a radially inward leading edge lip 84 and a radially outward leading edge lip 86, each of which can be any given distance away from a left side wall 88 and right side wall 90. In some forms the radially inward leading edge lip 84 and/or the radially outward leading edge lip 86 may not be present. The exhaust flow tubes 78 can be attached to the gas turbine engine outlet through either the radially inward leading edge lip 84 and radially outward leading edge lip 86, but if no leading lips are present in the particular embodiment of exhaust flow tubes 78, then the exhaust flow tubes 78 can be attached to the turbine exit through other structure.

Though the exhaust flow tubes 78 as described above can be engaged with neighboring exhaust flow tubes 78, in some forms intermediate structure may be present to couple the exhaust flow tubes 78 into the annular array of exhaust flow tubes 78. Such intermediate structure can also have cyclic symmetry in that a left and right side of the intermediate structure can be engaged with any given left side 80 and right side 82 of the new exhaust flow tubes 78, such that the exhaust flow tubes 78 can be manufactured as an interchangeable part in a similar manner as described above.

The exhaust flow tubes 78 can have an S-shaped length 92 as can be seen most clearly in FIG. 2a. The S-shaped length 92 can be used to reduce a line of sight between the outlet 72 and the inlet 68 or can be used to eliminate a line of sight between the outlet 72 and the inlet 68. The exhaust flow tubes 78 also can be used to diffuse an exhaust flow EF by increasing the cross-sectional area along the length of exhaust flow tubes 78. This can be seen in FIG. 3 wherein the upstream end 68 of the exhaust flow tubes 78 has a smaller cross-sectional area than the outlet 72 of the exhaust flow tubes 78.

Turning now to FIG. 4, the mixer 62 can include supports. In the illustrated form, an assembly of individually constructed exhaust flow tubes 78 is shown as being constructed into an annular array of exhaust flow tubes 78 coupled with structure on the inner periphery and outer periphery of the exhaust flow tubes 78. In particular, the assemblies of exhaust flow tubes 78 are coupled with an inner support ring 94 and an outer support ring 96. The inner support ring 94 and outer support ring 96 assist in coupling the exhaust flow tubes 78 with each other. In some forms the inner support ring 94 can be used to couple with an inner periphery of each of the exhaust flow tubes 78 present in the annular array of exhaust flow tubes, but in some forms the inner support ring 94 can be used to couple less than all of the exhaust flow tubes 78 in the annular array. Likewise, the outer support ring 96 can be coupled with the outer periphery of each of the individual exhaust flow tubes 78 in the annular assembly, but in some forms the outer support ring 96 can be used to couple with fewer than all of the exhaust flow tubes 78. In different embodiments other structures can be used to support the exhaust flow tubes 78.

One aspect of the present application provides an individually constructed exhaust flow tube that is combined with other individual exhaust flow tubes to create a mixer having an annular array of the exhaust flow tubes. The tubes can be spaced apart over a portion of their lengths and a cooling space can be formed therebetween. Exhaust flow exiting the exhaust flow tubes can be intermixed with a cooling air flowing around, along, and between the exhaust flow tubes.

One embodiment of the present application provides an apparatus comprising a gas turbine engine exhaust component including a flow tube structured to convey an exhaust flow from a gas turbine engine, the gas turbine engine exhaust component operable to be integrated with a plurality of gas turbine engine exhaust components each having a flow tube wherein the integrated assembly forms an annular plurality of flow tubes that are structured to convey the exhaust flow and mix it with a cooling air, the gas turbine engine exhaust component operable to be interchanged with another of the plurality of gas turbine engine exhaust components.

A further embodiment of the present application provides an exhaust mixer having an upstream end operable to be coupled with a gas turbine engine and a downstream end operable to convey a mixture of exhaust flow from the gas turbine engine and a cooling flow, the exhaust mixer including a plurality of flow tubes structured to convey the exhaust flow and each including an upstream end, a downstream end, a curved internal passage operable to reduce a line of sight from the downstream end to the upstream end, and an outer periphery surrounding the curved internal passage having lateral portions, an exterior surface portion, and an interior surface portion, a cooling space operable to convey the cooling flow between lateral portions of adjacent flow tubes, interior to the interior surface portion of each of the plurality of flow tubes, and out the downstream end, and wherein each of the flow tubes is constructed as a separable component operable to be removed from the exhaust mixer and replaced with another flow tube.

Another embodiment of the present application provides an apparatus comprising an exhaust mixer having an upstream end operable to be coupled with a gas turbine engine and a downstream end operable to convey a mixture of exhaust flow from the gas turbine engine and a cooling flow, the exhaust mixer including a plurality of flow tubes supported by a cantilever and structured to convey the exhaust flow and each including an upstream end, a downstream end, a curved internal passage operable to reduce a line of sight from the downstream end to the upstream end, and an outer periphery surrounding the curved internal passage having lateral portions, an exterior surface portion, and an interior surface portion, and a cooling space operable to convey the cooling flow between lateral portions of adjacent flow tubes, interior to the interior surface portion of each of the plurality of flow tubes, and out the downstream end.

A further embodiment of the present application provides a method comprising inserting a gas turbine engine exhaust tube material into a hydroforming die operable to manufacture multiple gas turbine engine exhaust tubes each having an inlet and an outlet, applying a hydraulic pressure force to a side of the gas turbine engine exhaust tube material, and forming the gas turbine engine exhaust tube material into a gas turbine engine exhaust tube having a curved length operable to reduce a line of sight between an inlet and an outlet and a diffused flow area along the curved length.

Yet a further embodiment of the present application provides a method comprising locating a standalone first exhaust flow tube component having a curved length in relation to a partially constructed gas turbine engine mixer assembly having an annular array of flow tubes when construction is completed, and fastening the standalone first exhaust flow tube component to form an at least partial annular array of flow tubes.

Still a further embodiment of the present application provides a method comprising inserting a gas turbine engine exhaust tube material into a hydroforming die operable to manufacture multiple gas turbine engine exhaust tubes each having an inlet and an outlet, applying a hydraulic pressure force to a side of the gas turbine engine exhaust tube material, and forming the gas turbine engine exhaust tube material into a gas turbine engine exhaust tube having a curved length operable to reduce a line of sight between an inlet and an outlet.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a gas turbine engine exhaust component including a flow tube structured to convey an exhaust flow from a gas turbine engine, the gas turbine engine exhaust component operable to be integrated with a plurality of gas turbine engine exhaust components each having a flow tube wherein the integrated assembly forms an annular plurality of flow tubes that are structured to convey the exhaust flow and mix it with a cooling air, the gas turbine engine exhaust component operable to be interchanged with another of the plurality of gas turbine engine exhaust components.

2. The apparatus of claim 1, wherein the flow tube includes openings at two ends and a curved passage intermediate the two ends and operable to reduce a line of sight between the two ends.

3. The apparatus of claim 2, wherein the flow tube is s-shaped.

4. The apparatus of claim 1, which further includes the plurality of gas turbine engine components, each of the plurality of gas turbine engine components includes identical first portions and identical second portions.

5. The apparatus of claim 3, wherein each of the plurality of gas turbine engine components includes a single flow tube.

6. The apparatus of claim 4, wherein the plurality of gas turbine engine components each include an inlet side having a first portion and a second portion, the first portion operable to be received by the second portion when the plurality of the gas turbine engine exhaust components forms the annular plurality of flow tubes.

7. The apparatus of claim 4, wherein the plurality of gas turbine engine exhaust components include front portions and rear portions and are joined by a ring in the rear portions.

8. The apparatus of claim 1, wherein the flow tube provides for a diffusion of exhaust flow over at least a portion of a length of the flow tube.

9. An apparatus comprising:
an exhaust mixer having an upstream end operable to be coupled with a gas turbine engine and a downstream end operable to convey a mixture of exhaust flow from the gas turbine engine and a cooling flow, the exhaust mixer including a plurality of flow tubes structured to convey the exhaust flow and each including an upstream end, a downstream end, a curved internal passage operable to reduce a line of sight from the downstream end to the upstream end, and an outer periphery surrounding the curved internal passage having lateral portions, an exterior surface portion, and an interior surface portion;
a cooling space operable to convey the cooling flow between lateral portions of adjacent flow tubes, interior to the interior surface portion of each of the plurality of flow tubes, and out the downstream end; and
wherein each of the flow tubes is constructed as a separable component operable to be removed from the exhaust mixer and replaced with another flow tube.

10. The apparatus of claim 9, wherein each of the flow tubes are cantilevered at their respective upstream ends

11. The apparatus of claim 10 which further includes an annular coupling structure coupled around the flow tubes.

12. The apparatus of claim 11, wherein the plurality of tubes are coupled through each of their respective outer peripheries.

13. The apparatus of claim 9, wherein each of the flow tubes is interchangeable with any other of the plurality of flow tubes.

14. The apparatus of claim 9, wherein the downstream end of at least some of the plurality of flow tubes is different than the downstream end of the other of the plurality of flow tubes.

15. The apparatus of claim 9, which further includes means for fastening the upstream ends of the plurality of flow tubes.

16. The apparatus of claim 9, wherein the flow tube includes a start angle oriented to match a turbine swirl angle of a gas turbine engine.

17. A method comprising:
inserting a gas turbine engine exhaust tube material into a hydroforming die operable to manufacture multiple gas turbine engine exhaust tubes each having an inlet and an outlet;
applying a hydraulic pressure force to a side of the gas turbine engine exhaust tube material; and
forming the gas turbine engine exhaust tube material into a gas turbine engine exhaust tube having a curved length operable to reduce a line of sight between an inlet and an outlet and a diffused flow area along the curved length.

18. The method of claim 17, wherein the forming further includes shaping the gas turbine engine exhaust tube material to have a diffused flow area along the curved length.

19. A method comprising:
locating a standalone first exhaust flow tube component having a curved length in relation to a partially constructed gas turbine engine mixer assembly having an annular array of flow tubes when construction is completed; and
fastening the standalone first exhaust flow tube component to form an at least partial annular array of flow tubes.

20. The method of claim 19, which further includes repairing the annular array of flow tubes by removing a standalone second exhaust flow tube component.

21. The method of claim 19, wherein the fastening includes mounting the flow tube component to a turbine exit of a gas turbine engine.

22. The method of claim 19, wherein the fastening includes coupling a support structure intermediate the ends of the annular array of flow tubes.
